(19) United States
(12) Patent Application Publication
(10) Pub. No.: US 2007/0155236 A1
(43) Pub. Date: Jul. 5, 2007

(54) WIRE HOLDER

(75) Inventors: Zheng Shi, Shenzhen (CN); Chien-Li Tsai, Tu-Cheng (TW); Guang-Yao Lee, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,267

(22) Filed: Jul. 21, 2006

(30) Foreign Application Priority Data
Dec. 30, 2005 (CN) 200520121456.X

(51) Int. Cl. H01R 13/40

(52) U.S. Cl. 439/587

(57) ABSTRACT

A wire holder for fixing one or more wires on a plate of an electronic device includes a pair of resilient latches and an elastic member. The pair of latches is formed on the plate, and each of the latches includes a latching portion for hooking the wire. The elastic member is formed between the pair of latches.

### CROSS-REFERENCES TO RELATED APPLICATION

Relevant subject matter is disclosed in the copending U.S. patent applications filed on the same date and having a same title with the present application, which are assigned to the same assignee with this patent application.

### 1. Field of the Invention

The present invention relates to a wire holder, and more particularly to a wire holder in an electronic device.

### 2. Description of Related Art

Typically, an electronic device such as a portable computer has a wire holding recess for fixing one or more wires therein. However, the wire holding recess may not fit the wires properly. If the wire holding recess is too wide, the wires are not fixed firmly and may fall out. If the wire holding recess is too narrow, the wires are fixed too firmly causing difficulty if they need to be removed, and the wires may be easily scraped during removal.

What is needed, therefore, is a wire holder in which wires are fixed firmly, but can still be easily removed when necessary.

### SUMMARY OF THE INVENTION

An exemplary wire holder for fixing one or more wires on a plate of an electronic device is provided. The wire holder includes a pair of resilient latches and an elastic member. The pair of latches is formed on the plate, and each of the latches includes a latching portion for hooking the wires. The elastic member is formed between the pair of latches.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, partially sectioned isometric view of a wire holder and a wire in accordance with a preferred embodiment of the present invention;

FIG. 2 is an enlarged isometric view of a circled portion II of FIG. 1;

FIG. 3 is a cross-sectional view taken along line III-III of FIG. 2; and

FIG. 4 is an assembled view of FIG. 1.

### DETAILED DESCRIPTION OF THE INVENTION

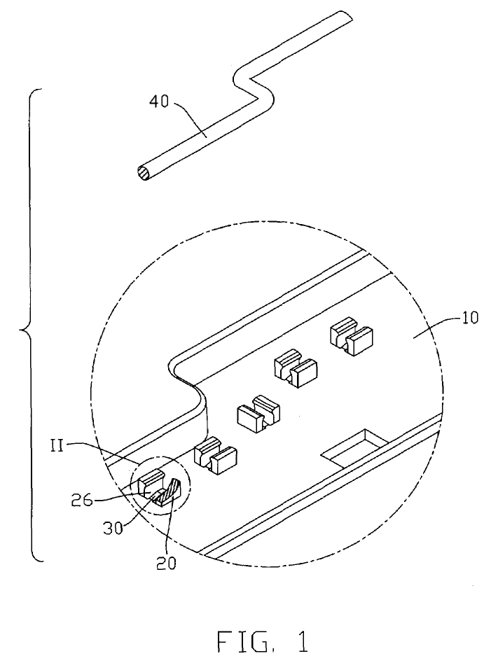

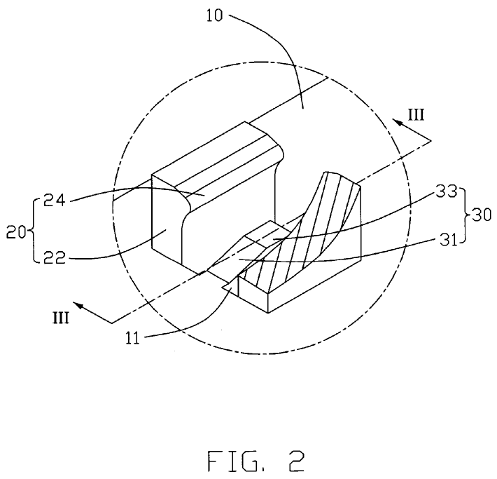

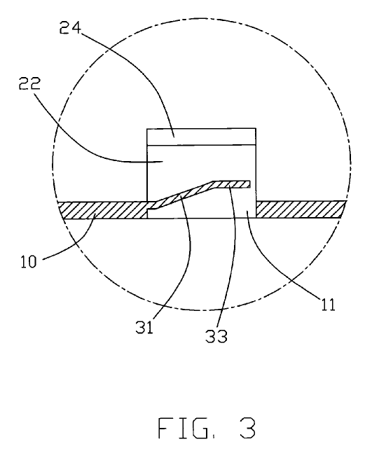

Referring to FIGS. 1 to 3, a wire holder for fixing a wire 40 on a plate 10 of an electronic device is provided in accordance with a preferred embodiment of the present invention. In other embodiments, the wire 40 may be more than one wire. The wire holder includes pairs of resilient latches 20 formed on the plate 10. In this embodiment, the electronic device is a portable computer, and the plate 10 is an inside surface of a panel of an enclosure of the portable computer.

An elastic member 30 is formed on the plate 10 between each pair of latches 20, and an aperture 11 is defined in the plate 10 under each of the elastic members 30, thereby the elastic members 30 overhang the corresponding aperture 11. Each elastic member 30 includes a tilted elastic arm 31 with one end thereof connected to the plate 10 adjacent an end of the corresponding aperture 11, and a resisting portion 33 extended from a free end of the elastic arm 31. Each latch 20 includes a main body 22 and a latching portion 24 extended from a top portion of the main body 22 and slightly overhanging the corresponding elastic member 30. Each pair of latches 20 cooperatively define a guiding slot 26 therebetween for receiving the wire 40.

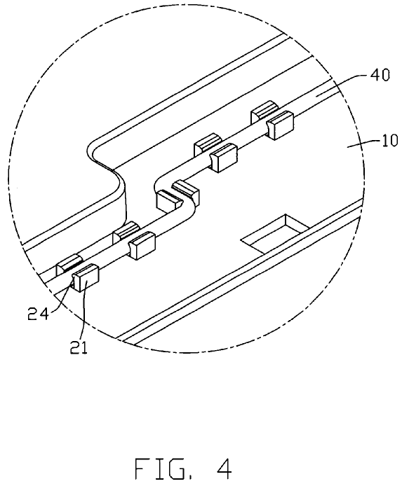

Referring also to FIG. 4, in assembly, the wire 40 is pressed into the guiding slots 26 of the pairs of latches 20 on the plate 10, and the latching portions 24 of each pair of latches 20 deform outward then rebound to press against the top of the wire 40, thereby the wire 40 is fixed in place. The resisting portions 33 of the elastic members 30 resist against an underside of the wire 40, and the elastic arms 31 are pressed down being received in the corresponding apertures 11.

To detach the wire 40 from the plate 10, the wire 40 is pulled up, which urges the latches 20 to deform away from each other, and with the aid of the elastic arms 31 resisting against the underside of the wire 40, the wire 40 is easily taken out by an operator.

Furthermore, the latches 20 can be arranged in many different patterns other than depicted in FIG. 4 according to desired paths for the one or more wires on any surface, within or without, of the electronic device. Further, the latches 20 need not be symmetrically aligned as in the preferred embodiment but rather, may be aligned offset from each other and the elastic members 30 formed at a point generally midway between each two latches 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A wire holder for fixing a wire on a plate of an electronic device, the wire holder comprising:
a pair of resilient latches formed on the plate, and each of the latches comprising a latching portion for hooking the wire; and
an elastic member formed between the pair of latches.

2. The wire holder as claimed in claim 1, wherein each of the latches comprises a main body, and the latching portion is formed on a top portion of the main body.

3. The wire holder as claimed in claim 1, wherein the latching portions of the pair of latches are formed toward each other.

4. The wire holder as claimed in claim 1, wherein an aperture is defined in the plate under the elastic member.

5. The wire holder as claimed in claim 4, wherein the elastic member comprises a tilted elastic arm connected to the plate adjacent an end of the aperture, and a resisting portion extended from a free end of the elastic arm.

6. The wire holder as claimed in claim 1, wherein the elastic member comprises a tilted elastic arm and a resisting portion extended from a free end of the elastic arm.

7. The wire holder as claimed in claim 1, wherein the pair of latches cooperates to form a guiding slot for receiving the wire.

8. A wire holder on a plate, comprising:
a plurality of resilient latches formed on the plate, the latches cooperatively defining a guiding slot therebetween for holding one or more wires; and
at least one elastic member formed on the plate, and extending into the guiding slot.

9. The wire holder as claimed in claim 8, wherein each of the latches comprises a main body and a latching portion formed on a top portion of the main body.

10. The wire holder as claimed in claim 9, wherein the latching portions of the latches are formed toward the guiding slot.

11. The wire holder as claimed in claim 8, wherein at least one aperture is defined in the plate under the at least one elastic member.

12. The wire holder as claimed in claim 11, wherein the elastic member comprises a tilted elastic arm connected to the plate adjacent an end of the aperture, and a resisting portion extended from a free end of the elastic arm.

13. The wire holder as claimed in claim 8, wherein the elastic member comprises a tilted elastic arm and a resisting portion extended from a free end of the elastic arm.
